(19) United States
(12) Patent Application Publication
(10) Pub. No.: US 2014/0335496 A1
(43) Pub. Date: Nov. 13, 2014

(54) HUMAN CONDUCTING AIRWAY MODEL COMPRISING MULTIPLE FLUIDIC PATHWAYS

(71) Applicants: Research Triangle Institute, Research Triangle Park, NC (US); The University of North Carolina at Chapel Hill, Chapel Hill, NC (US)

(72) Inventors: Sonia Grego, Durham, NC (US); Kristin Hedgepath Gilchrist, Durham, NC (US); Scott H. Randell, Durham, NC (US)

(73) Assignees: Research Triangle Institute, Research Triangle Park, NC (US); The University of North Carolina at Chapel Hill, Chapel Hill, NC (US)

(21) Appl. No.: 14/362,419

(22) PCT Filed: Dec. 4, 2012
(86) PCT No.: PCT/US2012/067774

§ 371 Date: Jun. 3, 2014

Related U.S. Application Data
(60) Provisional application No. 61/566,758, filed on Dec. 5, 2011.

(51) Int. Cl. G09B 23/30

(52) U.S. Cl. CPC G09B 23/306
USPC 434/272

(57) ABSTRACT

A multicellular fluidic enhanced airway model system of the conducting airways as a tool for the evaluation of biological threats and medical countermeasures is provided. The airway model system can include a first chamber having an inlet and an outlet and containing epithelial cells; a second chamber having an inlet and an outlet and containing an extracellular matrix, wherein the second chamber is separated from the first chamber by a porous membrane; and a third chamber having an inlet and an outlet, wherein the third chamber is separated from the second chamber by a porous membrane, and wherein the airway tissue model system is configured to provide a separate fluidic pathway through each of said first, second, and third chambers. A method of analyzing tissue response to an agent via an airway tissue model system is also provided.

### FIELD OF THE INVENTION

The present invention is directed to an integrated artificial tissue construct system and, in particular, an in vitro multilayer three-dimensional fluidic-enhanced cell-based model of conducting airways that reproduce epithelial function and the integrated epithelial—interstitial-microvasculature structure of the air—blood barrier in the lung.

### BACKGROUND OF THE INVENTION

The respiratory system is a prime site of exposure to natural and bioengineered pathogens, as well as an attractive drug delivery route. The human respiratory system consists of a gas-exchanging respiratory zone (alveoli) and the conducting airways that enable the essential gas transport function. The basic tissue structure includes an overlying epithelium, an interstitial chamber containing supportive extracellular matrix, and a vascular chamber. The epithelium forms a continuous first line defensive barrier whose cellular composition varies along the proximal to distal axis. The majority of the conducting airways are lined by a pseudostratified columnar epithelium consisting mainly of ciliated, mucous secretory, and basal cells. The epithelium provides innate host defense by: (i) forming a barrier to various insults; (ii) facilitating mucociliary clearance (by mucin secretion and cilia beat); (iii) secreting anti-microbials, antioxidants, and protease inhibitors; and (iv) modulating inflammatory cell influx (neutrophils, monocyte/macrophages). Scott H. Randell and R. C. Boucher, Am J Respir Cell Mol Biol (2006) 35: 20-28.

Airway epithelial cell cultures have been created to emulate the human airway. Fulcher, M. L., S. Gabriel, K. A. Burns, J. R. Yankaskas, and S. H. Randell, Methods in Molecular Medicine: Human Cell Culture Protocols (2005) 107. An in vitro cell-based platform capable of reproducing functionality mimicking the human response to respiratory challenges and to pulmonary delivered medical countermeasures and its relation to vasculature is a powerful tool to investigate pulmonary absorption characteristics. Such a platform also allows investigation of both local and systemic bioavailability of pulmonary-delivered therapeutics as well as disease studies. On conventional plastic culture dishes, the epithelial cells assume a poorly differentiated, squamous phenotype; however, when the cells are cultured on porous supports at an air liquid interface, a dramatic phenotypic conversion enables the cells to recapitulate their normal in vivo morphology. These cultures demonstrate vectorial mucus transport, high resistance to gene therapy vectors, and cell type—specific infection by viruses. With regard to disease studies and evaluation of drugs and other therapeutics, the advantage of human lung in vitro systems as compared to animal models is that the former avoids uncertainties regarding species-specific cellular responses and ambiguities due to human—animal anatomical differences.

Human airway epithelial cell cultures have been maintained at an air—liquid interface and achieve a high degree of differentiation and tissue functionalities (e.g., mucus secretion). Air—liquid interface Transwell cultures are extensively used and commercially available for studying respiratory diseases, toxicology, and pharmacology. Air—liquid interface cultures, however, represent only the overlying epithelium of the airway and do not reconstitute many critical features of in vivo lung tissue, most prominently vascularization. Such cultures are also typically maintained under static (no flow) conditions.

A cell-based model that captures the three-dimensional organization and the multicellular complexity of native tissues provides a useful tool with relevant response to toxicants, pathogens, and therapeutics. Microfluidic technologies offer advantages over traditional microtiter plates by enabling control of the cell's microenvironment, including interaction with other cells, extracellular matrix, and soluble factors. These elements affect cellular phenotypes and more accurately mimic the in vivo tissue. A number of microfluidic perfusion systems have been developed for cell cultures, mostly aimed at developing new tools for drug and vaccine research with a focus on liver models. See U.S. Patent Publication No. 2006/0275270; see also Kim, L., Y. C. Toh, J. Voldman, and H. Yu, Lab Chip (2007) 7: 681-694; Wu, M.-H., S.-B. Huang, and G. B. Lee, Lab Chip (2010) 10: 939-956.

Microfluidic models of the lung have been investigated including a multilayer co-culture of human bronchial epithelial cells placed directly on fibroblasts in collagen, and cultures of lung epithelial cells on nanoporous membranes to better define the air—liquid interface. Tomei, A. A., M. M. Choe, and M. A. Swartz, Am J Physiol Lung Cell Mol Physiol (2007) 294: L79-L86; Huh, D., H. Fujioka, Y.-C. Tung, N. Futai, R. Paine, J. B. Grotberg , and S. Takayama, Proc. Natl. Acad. Sci. USA (2007) 104: 18886-18891. A culture of endothelial and epithelial cells on the opposite sides of the same nanoporous membrane has been reported to mimic vascularization. Huh, D., B. D. Matthews, A. Mammoto, M. Montoya-Zavala, H. Y. Hsin, and D. E. Ingber, Science (2010) 328: 1662-1668;. Co-cultures of endothelial cells, smooth muscle cells, and fibroblasts in a collagen matrix have also been reported. Tan, W. and T.A. Desai, J. Biomed. Mat. Res. (2005) 172: 146-160. In all of these approaches, the same fluid (or air and fluid) interacts with all of the cells in the co-culture, which does not allow for optimized cell growth and differentiation. Most of the microfluidic approaches known in the art utilize transformed cell lines, which are easier to obtain and maintain as compared to primary cells isolated from tissue, but fail to mimic in vivo physiology as closely as primary cells.

In view of the threat of aerosolized pathogens and the potential for their rapid, widespread administration, methods are needed to rapidly elucidate and evaluate pulmonary absorption characteristics and systemic bioavailability. There further remains a need for a method of simulating the human airway.

### SUMMARY OF THE INVENTION

The present invention provides a multicellular three-dimensional fluidic enhanced airway model system of conducting airways as a tool for the evaluation of biological threats and medical countermeasures. The instant invention also provides the unique capability to investigate both local and systemic bioavailability and mechanisms of modulation. Specifically, the present invention provides the capability to measure the permeability of compounds through the epithelia and the underlying endothelium and vascular cells. Barrier integrity, active transport, and functional expression of drug efflux pumps may also be evaluated. The present invention also provides a platform to test drug therapies thereby mitigating injury and facilitating repair. As a result, clinically relevant information is obtained earlier in the drug development process, thereby preserving research and development expenses.

According to one aspect of the invention, an airway tissue model system is provided. The system includes a first chamber having an inlet and an outlet and containing epithelial cells. Thus, the epithelial cells are grown at an air-liquid interface in the first chamber. The epithelial cells can be human bronchial epithelial cells. The system can further include a second chamber having an inlet and an outlet and containing an extracellular matrix. In one embodiment, the extracellular matrix comprises fibroblasts embedded therein. The extracellular matrix can comprise collagen. The second chamber can be separated from the first chamber by a porous membrane. The system further can include a third chamber having an inlet and an outlet. In one embodiment, the third chamber can contain endothelial cells. The endothelial cells can be human lung microvascular endothelial cells. The third chamber can be separated from the second chamber by a porous membrane. The airway tissue model system can be configured to provide a separate fluidic pathway through each of the first, second, and third chambers. The first, second, and third chambers can be arranged vertically with the first chamber above the second and third chambers in a vertical plane. The system is a multi-layer microfluidic device where each of the first, second, and third chambers forms a separate layer of the device. The fluidic pathways can be configured to independently deliver air or liquid media to each of the first, second, and third chambers. In certain embodiments, each chamber and each porous membrane is constructed of an optically transparent material.

The porous membranes are typically adapted to provide support for cell attachment and growth and to allow diffusion therethrough. Exemplary porous membranes have a pore size from about 300 nm to about 500 nm. Each porous membrane can be, for example, a nanoporous polyester terephthalate membrane.

The thicknesses of the various chambers can vary. Typically, the thickness of the second chamber is configured to approximate the capillary-to-epithelium distance in the human conducting airways. In certain embodiments, one or more of the various chambers will have thicknesses as follows: i) the first chamber has a thickness of about 400 μm to about 700 μm; ii) the second chamber has a thickness of about 50 μm to about 200 μm; and iii) the third chamber has a thickness of about 100 μm to about 300 μm.

In one embodiment, the airway tissue model system of the invention includes the first chamber vertically arranged above the second chamber, wherein the fluidic pathway through the first chamber is microfluidic and adapted to supply either air or a media adapted to support cell growth and differentiation to the first chamber; a first porous membrane separating the first chamber from the second chamber and having the epithelial cells seeded on a surface thereof facing the first chamber, the first porous membrane adapted to provide support for cell attachment and growth and to allow diffusion therethrough; the second chamber having a thickness configured to approximate the capillary-to-epithelium distance in the human conducting airways and wherein the fluidic pathway through the second chamber is microfluidic and adapted to supply a media adapted to support cell growth and differentiation to the second chamber; a second porous membrane separating the second chamber from the third chamber, the second porous membrane adapted to provide support for cell attachment and growth and to allow diffusion therethrough; and the third chamber vertically arranged below the second chamber, wherein the fluidic pathway through the third chamber is microfluidic and adapted to supply either a media adapted to support cell growth and differentiation or a fluid adapted to pharmacokinetically mimic blood flow in a human to the third chamber.

According to another aspect, a method of analyzing tissue responses to agents administered to the airway tissue model system of the invention is provided. The method includes the steps of administering an agent to one or more chambers of the airway tissue model system and evaluating any physiological response by, or injury to, tissue present in one or more of the chambers, such as epithelial cells, extracellular matrix, or endothelial cells. The agent can be at least one drug or pathogen and may be delivered to one or more chambers simultaneously or in sequence. Exemplary drugs that can be administered include β2-agonists, corticosteroids, antibiotics, mucolytics, chemotherapy agents, gene therapy agents, vaccines, analgesics, antiemetics, and hormones.

In one embodiment, the method further comprises introducing neutrophils into the fluidic pathway through the third chamber, wherein the evaluating step comprises evaluating transmigration of neutrophils into the first and second chambers. In another embodiment, the method is adapted to analyze epithelial repair and comprises inducing an injury to at least a portion of the epithelial cells and the evaluating step comprises evaluating epithelial regeneration.

### BRIEF DESCRIPTION OF THE DRAWINGS

FIG. 1 is a cross-sectional view of a fluidic enhanced airway model system according to one embodiment.

FIG. 2 is a schematic of one embodiment of a fluidic enhanced airway model system.

FIG. 3 illustrates an exploded geometric embodiment of the fluidic enhanced airway model system.

FIG. 4 illustrates gravity-driven flow induced by the height difference of reservoirs according to one embodiment.

FIG. 5(a) illustrates an exploded view of a three-layer fluidic system according to one embodiment.

FIG. 5(b) illustrates an assembled fluidic enhanced airway model system according to one embodiment.

FIG. 6 illustrates one embodiment of the present system that can be used for extravasation experiments of white blood cells.

FIG. 7 illustrates one embodiment of the present system that can be used to study pulmonary absorption.

### DETAILED DESCRIPTION OF THE INVENTION

As used herein, the term “fluid” refers to air, liquid, or a combination thereof.

As used herein, the term “fluidic” refers to system or apparatus adapted for transport of a fluid therethrough.

As used herein, the term “microfluidic” refers to a fluidic pathway that includes at least one dimension of less than one millimeter.

As used herein, the tem' “pathogen” refers to a microorganism such as a virus, bacterium, prion, or fungus that may cause disease in a host organism.

As used herein, the term “agent” refers to any chemical or biological compound or composition such as a drug, toxin or pathogen intended to elicit a response from the cells of the microfluidic system of the invention.

An in vitro multilayer three-dimensional fluidic-enhanced airway model system that reproduces not only an epithelial function, but encompasses the integrated epithelial—interstitial-microvasculature structure of the human air—blood barrier is provided. Independent fluidic culture medium is provided for the each layer recapitulating the morphology and physiology of the tissue mucosas barrier including an epithelial layer, an extracellular matrix stromal layer and an endothelial layer. Thus, the present system mimics vasculature lining to create a “mucosal tissue equivalent” or in vitro tissue surrogate.

Cells utilized in the model system can be primary cells. Primary cells can be obtained from non-human mammalian (e.g., rat, mouse, primate) or human sources, with primary human cells being most preferred. Embryonic stem (ES) cells or induced pluripotent stern (iPS) cells directed to the differentiation status of any of the three cell types used in the systems of the invention can also be used.

### System Structure and Design

The system of the present invention includes artificial porous membranes on either side of an extracellular matrix layer that mimics the mucosal interstitium. The two porous membranes can be located on opposite sides of the extracellular matrix to support growth of epithelial and endothelial cells, respectively, and support the fluidic channels. Independent microfluidic channels can enable independent media choices for simultaneous growth and differentiation of the cell layers. As a result, the flow through or around the extracellular matrix can be established and controlled.

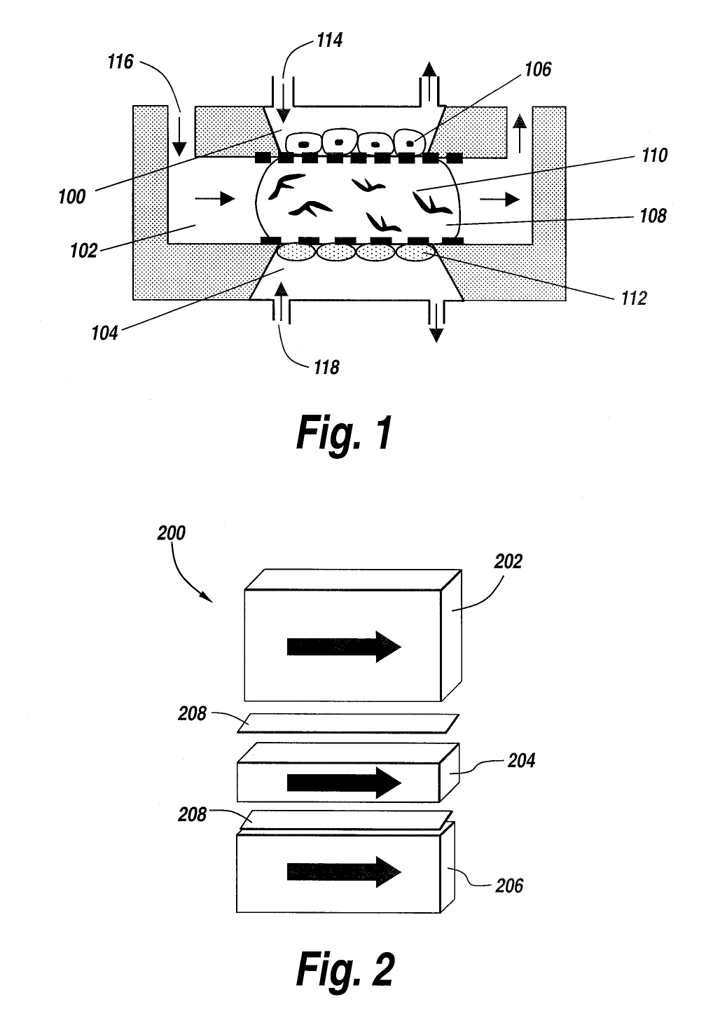

Self-contained engineered fluidic chambers enable independent control and access to the three cell types (i.e., bronchial epithelial cells, extracellular matrix cells including fibroblasts, and microvascular endothelial cells) in three separate chambers. Referring to FIG. 1, the first 100 (i.e., upper), second 102 (i.e., intermediate) and third 104 (i.e., lower) chambers correspond to the epithelial chamber (i.e., “apical” or “airway lumen”) containing bronchial epithelial cells 106, the extracellular matrix interstitium, and the microvascular chamber, respectively. As illustrated in FIG. 1, the extracellular matrix in the second chamber 102 can include collagen 108 and fibroblasts 110 that mimic the interstitium. The collagen 108 and fibroblasts 110 can be sandwiched between the polarized epithelium 106 grown at an air—liquid interface and a microvascular endothelial cell layer 112 representing blood capillaries. The polarized microvascular endothelial cell layer 112 is typically provided to collectively mimic the tissue-blood barrier. A first medium 114, a second medium 116, and a third medium 118, each passing through one of the three chambers, can be independently controlled.

Referring to FIG. 2, the fluidic-enhanced airway model system 200 can include a triple flow microfluidic pathway with separate effluent collection for subsequent analysis. The arrows show the direction of medium flow within the system 200 according to one embodiment. The first 202 (i.e., upper), second 204 (i.e., intermediate) and third 206 (i.e., lower) regions or chambers can be separated by two porous membranes 208. According to a preferred embodiment, the two porous membranes 208 are nanoporous polymer membranes. The two porous membranes 208 provide optically transparent support for cell attachment and growth while allowing solute diffusion and cellular signaling between chambers. The thickness of the intermediate region or chamber 204 is typically from about 50 μm to about 200 μm to approximate the capillary-to-epithelium distance in the conducting airways. In a preferred embodiment, the thickness of the intermediate region or chamber 204 is about 100 μm. The remaining geometric parameters are dictated by fluidic requirements.

In one embodiment, the system of the present invention can be maintained at typically about 30° C. to about 45° C. and typically about 1% to about 10% CO₂ by placing the system in an incubator. In a preferred embodiment, the system is maintained at about 37° C. and about 5% CO₂.

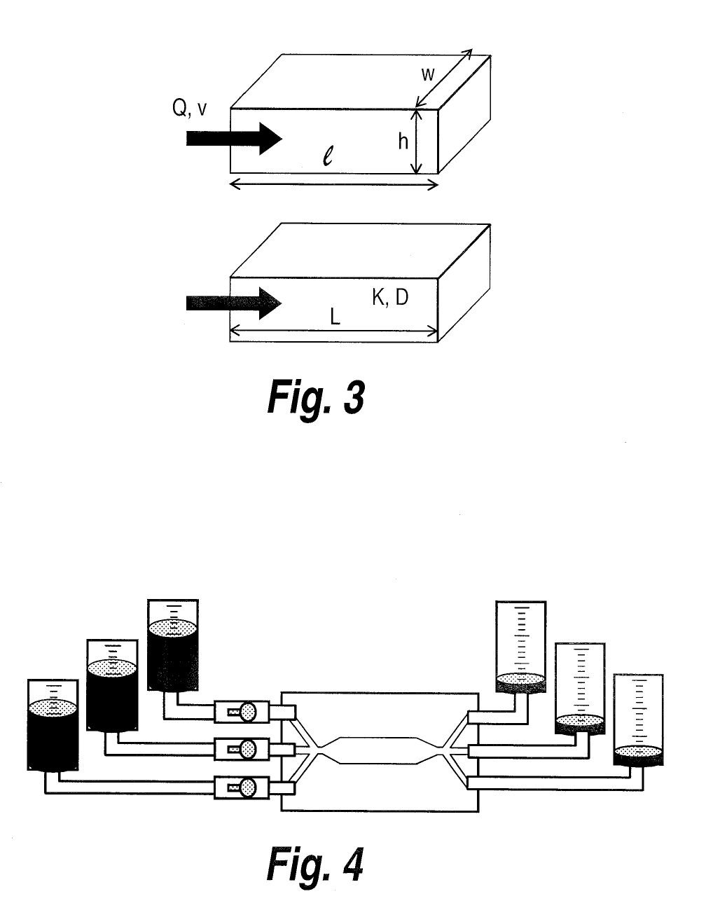

In a preferred embodiment, the system includes an internal flow system. In one embodiment, the flow system can include tubing channels that are connected by inserting metallic needles into holes punched in a polymer device containing microfluidic channels. Channels are used to flow liquid or air for air-culture-requiring epithelia such as lung and dermal tissue. Continuous flow replenishes the culture based on the small volume of the microfluidic chamber. Gravity-driven flow induced by the height difference of reservoirs (See Equation 7—Table 2; see FIGS. 3 and 4) can be utilized to provide a convenient, low cost, and easily multiplexed means of imparting flow to three separate channels for an extended period of time. Gravity-based flow enables storage in an incubator without external pumping. Gravity-driven flow has been used both in cell culture and in flow-through collagen systems. Lee, P. J., N. Ghorashian, T. A. Gaige, and P. J. Hung, J. of the Association Laboratory Automation (2007) 12: 363-367. As illustrated in FIG. 4, by decreasing height difference over time, a negligible flow change between reservoirs refills can be achieved. Unattended operation at the required flows can be achieved with a height difference of from typically about 15 mm to about 25 mm. In one embodiment, unattended operation at the required flows can be achieved with a height difference of about 20 mm for the intermediate chamber. The desired flow for the epithelial and vascular chambers can be achieved by adding fluidic resistance.

In one embodiment, three inlets and outlets respectively connect to small media reservoirs, which may be replenished as needed. A syringe pump can enable a more controlled flow velocity for sample introduction during assays. Samples from each tissue chamber can be taken for assays, using both application of the samples to reservoirs and a four-way valve and syringe pump for timed delivery. Plugs, valves, and bubble traps can be implemented to avoid creation of bubbles which disrupt culture flow.

In one embodiment, the system includes a multiplexed chamber. A layered fabrication approach can be used with nanoporous membranes sandwiched between patterned polymer layers. A modified 96-well plate or custom acrylic sheet can be used as an additional top layer to create inlet and outlet reservoirs with access to the appropriate channels. A glass or acrylic backing layer can be utilized to enable bottom viewing. A variety of techniques for placement of Transwell membranes can be used, including a precision bonding machine. A polymer sheet can be applied in sheets large enough to cover the entire model system.

In one embodiment, the system includes at least 6 wells for each independent co-culture (inlet and outlet for three separate chambers). Additional wells can be included for cell seeding. In an alternative embodiment, the model system enables four to eight cultures on a 96-well plate footprint.

In one embodiment, the system footprint is typically about 40 mm×60 mm. Overall dimensions of the present system, however, may be modified to accommodate various sized membranes. The thickness of the system is typically from about 0.1 mm to about 10 mm. The system can also be scaled up for high throughput screening tests.

To aid in microscopic observation, a thin viewing window can be utilized. Inlet and outlet separation can accommodate microscope objectives. A plastic housing (not shown) can compress the porous polymer layer to reduce the risk of leakage and provide mechanical support to fluidic tubing. In on embodiment, an open epithelial chamber for direct access to the epithelium is provided.

In one embodiment, the system of the present invention can be assembled by gluing the respective membrane to the respective chamber component. Once the multi-flow system is assembled, then cells are flowed into place (i.e., seeded). The extracellular matrix can be delivered as a monomer (typically mixed with cells) and gelled in situ (e.g., by raising the temperature to about 37° C. for collagen).

### Epithelial Chamber

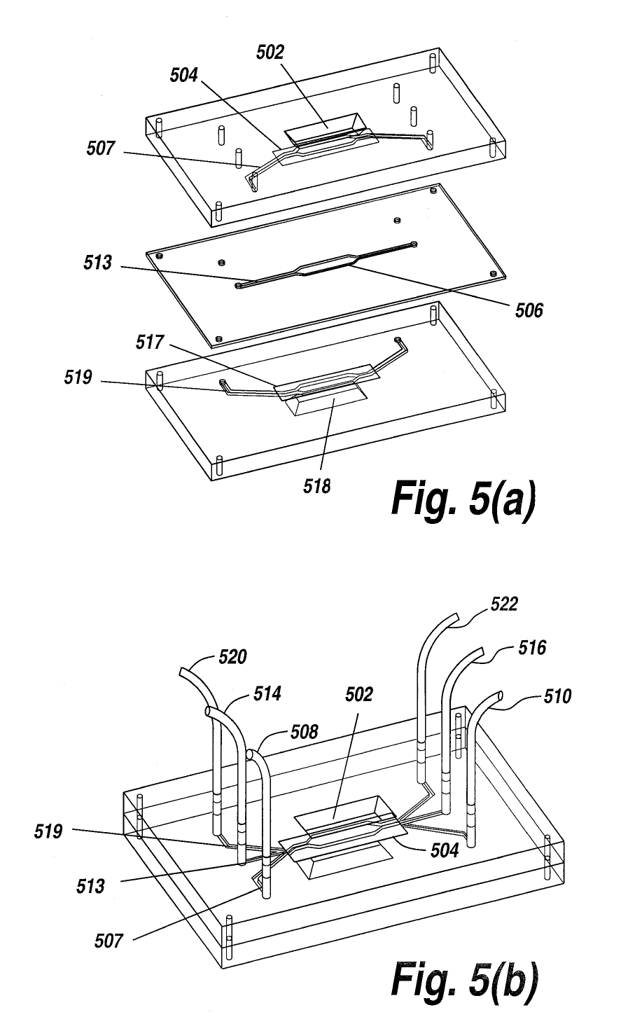

Referring to FIGS. 5(a) and 5(b), the epithelial chamber 502 is typically positioned as a first or top chamber in the model system. A nanoporous membrane 504 is positioned between the epithelial chamber 502 and extracellular matrix chamber 506. Tubing 507 is inserted in the epithelial chamber 502 to provide a means of supplying a medium to the epithelial tissue cells. At least one inlet 508 and outlet 510 of the tubing respectively connect to small media reservoirs (shown, for example, in FIG. 4). The media flowed to the epithelial tissue cells can be a tissue-specific media to aid the epithelial tissue's growth and differentiation.

The epithelial tissue can include tracheal and bronchial epithelial cells that can be procured by protease dissociation and cultured on plastic with methods known to those skilled in the art, yielding 50-150×10⁶ passage cryopreserved human bronchial epithelial cells (HBECs) per lung. Fulcher, M. L., S. Gabriel, K. A. Bums, J. R. Yankaskas, and S. H. Randell, Methods in Molecular Medicine: Human Cell Culture Protocols (2005) 107. Frozen cryopreserved aliquots of cells are continuously available for establishing the in vitro model of the present invention.

### Extracellular Matrix Chamber

Referring again to FIGS. 5(a) and 5(b), the extracellular matrix chamber 506 is positioned as the second or middle chamber in the model system. Tubing 513 is inserted in the extracellular matrix chamber 506 to provide a means of supplying a medium to the extracellular matrix cells. At least one inlet 514 and outlet 516 of the tubing respectively connect to small media reservoirs (shown, for example, in FIG. 4). The media flowed to the extracellular matrix tissue cells can be a tissue-specific media to aid the extracellular matrix tissue's growth and differentiation.

In a preferred embodiment, the second chamber includes an extracellular matrix that can include fibroblasts, smooth muscle cells, dendritic cells, monocyte, macrophages, mast cells, T cells and B cells, or a combination thereof. The extracellular matrix is typically a hydrogel foimed using a variety of materials, including natural gels such as, for example, collagen type I or MATRIGEL™ matrix materials, synthetic gels, self-assembling peptide gels, and polyethylene glycol gels. Additional exemplary gels include, but are not limited to, poly(methyl) methacrylate, poly(lactide-co-glycolide), polytetrafluoroethylene, poly(ethylene glycol dimethacrylate)hydrogels, poly(ethylene oxide), poly(propylene fumarate-co-ethylene glycol), hyaluronic acid hydrogels, calf skin gelatin, fibrinogen, thrombin, and decellularized ECM (e.g., matrix derived from small intestine submucosa or bladder mucosa). In a preferred embodiment, the second chamber includes an extracellular matrix that includes a collagen scaffold embedded with fibroblast cells. Primary fibroblasts are typically procured from the same lungs as human bronchial epithelial cells, using minced tissue explant culture methods and established protocols. Due to the extensive cell numbers and growth capacity, essentially unlimited numbers of fibroblasts are made available by these procedures. In certain embodiments, the central chamber can include only the extracellular matrix without cell seeding (e.g., acellular collagen).

Interstitial flow (e.g., lymph) through extracellular matrix occurs extensively in living tissue and has been investigated in microfluidic platforms. Swartz, M. A. and M. E. Fleury, Annu. Rev. Biomed. Eng. (2007) 9: 229-56; Chung, S., R. Sudo, V. Vickerman, I. K. Zervantonakis, and R. D. Kamm, Ann. of Biomed. Eng. (2010) 38: 1164-1177; Bonvin, C., J. Overney, A. C. Shieh, J. B. Dixon, and M. A. Swartz, Biotechnol.and Bioeng. (2009) 105: 982-990; See also U.S. Pat. Nos. 7,670,797 and 7,960,166, each of which are incorporated herein by reference. Physiological flow velocities of typically about 0.1 μm/s to about 1 μm is can be obtained at flow rates of typically from about 0.1 μL/hour to about 1 μL/hour. The medium resident time should be sufficient for molecule exchange with the neighboring layers by diffusion (Equation 6—Table 2; see FIG. 3) across the nanoporous membranes. The flow through a porous medium is described by Darcy's law (Equation 5—Table 2; see FIG. 3) which relates the interstitial flow velocity, vᵢ, to the pressure drop,ΔP.

The extracellular matrix chamber can formed from a material that forms a tight interface with the epithelial and endothelial vascular surfaces. Microscale cell-seeded matrices have been intensely investigated to produce three-dimensional cellular microenvironments. Gillette, B. M., J. A. Jensen, B. Tang, G. J. Yang, A. Bazargan-Lari, M. Zhong, and S. K. Sia, Nat. Mat. (2008) 7: 636-640; Desai, T. A. and Tan W., Tissue Engineering (2003) 9: 255-267. Pressure-driven flow through porous collagen is achieved in tight contact with the epithelial and endothelial vascular surfaces of the flow channel. In an alternative embodiment, multiple collagen-cell solution applications from a secondary inlet can be employed. To avoid gel contraction by the fibroblasts, collagen can be anchored to pre-coated chamber walls.

### Endothelial Vascular Chamber

Referring still further to FIGS. 5(a) and 5(b), the endothelial chamber 518 is typically positioned as the third or bottom chamber in the model system. A nanoporous membrane 517 is positioned between the endothelial chamber 518 and the extracellular matrix chamber 506. Tubing 519 is inserted in the endothelial matrix chamber to provide a means of supplying a medium to the endothelial cells. At least one inlet 520 and outlet 522 of the tubing respectively connect to small media reservoirs (shown, for example, in FIG. 4).

The media flowed to the endothelial tissue cells can be a tissue-specific media to appropriately support endothelial cell growth and differentiation. The media can also be a fluid adapted to pharmacokinetically mimic blood flow in a human. The blood material can include whole blood or a composition comprising a component of whole blood including platelets or red blood cells, or an oxygen-carrying blood substitute including hemoglobin-based oxygen carriers, crosslinked and polymerized hemoglobin, and perfluorocarbon-based oxygen carriers.

Primary human lung microvascular endothelial cells (HLMVEC) are preferably used in the endothelial vascular chamber. Alternatively, human umbilical vein endothelial cells (HUVEC) could be used. In certain embodiments, the endothelial chamber does not contain cells. For example, certain pulmonary absorption experiments can be conducted without endothelial cells. A design specification for one embodiment of the model system of the present invention is provided in Table 1.

TABLE 1
Design Specification

| | | | Extracellular | | | |
|---|---|---|---|---|---|---|
| Parameter | Epithelial | | Matrix | | Endothelial | |
| Cell type | Human bronchial | | Human lung | | Human lung microvascular | |
| | epithelial cells | | fibroblasts | | endothelial cells | |
| Support | 0.4 μm pore | | Collagen | | 0.4 μm pore | |
| | PET membrane | | 2-4 mg/mL | | PET membrane | |
| Chamber height | 500 | μm | 100 | μm | 200 | μm |
| Chamber area | 10 × 3 | mm² | 10 × 3 | mm² | 10 × 3 | mm² |
| Chamber volume | 15 | μL | 3 | μL | 6 | μL |
| Seeding cell | 2 × 10⁵/cm² | | 10⁵ | cells/mL | 2 × 10⁵/cm² | |
| density | | | | | | |
| Flow in culture | 7.5 | μL/min | 0.03 | μL/min | 2 | μL/min |
| Media refresh time | 2 | min | 100 | min | 3 | min |

### Geometric Parameter Design

Equations for flow at low Reynolds numbers in microfluidic channels are provided in Table 2 and correspond to the construct of FIG. 3. The following parameter definitions are illustrated: Q=flow rate, v=flow velocity, □=medium viscosity; R=channel resistance, □P=pressure drop; vi=interstitial flow velocity; K=permeability; D=diffusivity coefficient, t=time, □H=liquid height difference.

TABLE 2
Table 2: Equations

| | |
|---|---|
| v = Q/(wh) | [1] |
| T = 6□Q/(h²w) | [2] |
| R~12 □l/h³w | [3] |
| Q = ΔP/R | [4] |
| vᵢ = −K ΔP/(□L) | [5] |
| □x = 2√Dt | [6] |
| ΔP_{gravity} = □gΔH | [7] |

A porous membrane between two liquid flows reduces convective transport between microfluidic compartments because of the larger hydraulic resistance of the membrane as opposed to the channel. Flow in the three microfluidic channels can occur independently as long as the pressure along the flow channel is less than the leakage threshold of the separating membrane. Ismagilov, R. F., J. M. K. Ng, P. J. A. Kenis, and G. M. Whitesides, Anal. Chem. (2001) 73: 5207-5213; Zhu, X., Microsyst. Technol. (2009) 15: 1459-1465; Aran, K., L. A. Sasso, N. Kamdar, and J. D. Zahn, Lab Chip (2010) 10: 548-552. When an air-liquid interface is established instead of a liquid-liquid interface, the liquid in the lower compartment remains contained as long as the pressure along the flow channel is not larger than the water leak threshold. The water leak threshold depends on the membrane properties and is typically of the order of about 20 psi for submicron pore membranes. Zhu, X., Microsyst. Technol. (2009) 15: 1459-1465. The operating pressure in cell culture devices are much lower as dictated by the requirement of fluid flow Q (Equation 1—Table 2; see FIG. 3) to impart an acceptable shear stress T (Equation 2—Table 2; see FIG. 3) on the cells (e.g., T<<1 dyn/cm²).

A 500-μm epithelial chamber height is such that Q=7.5 μL/min, which, in turn, corresponds to T=0.01 dyn/cm². Such a height will accommodate fully differentiated, pseudostratified epithelia (30- to 50-μm thick) and a secreted mucus layer. A 200-μm vascular chamber height provides low shear stress for flow on the order of a few microliters per minute, but enables a high shear stress (e.g., T=1 dyn/cm² for Q=180 μL/min), similar to in vivo values for vascular endothelial cells. Kim, L., Y.-C. Toh, J. Voldman, and H. Yu, Lab Chip (2007) 7: 681-694; Wu, M.-H., S.-B. Huang, and G.-B. Lee, Lab Chip (2010) 10: 939-956. Using estimates of the hydraulic resistance R (Equation 3—Table 2; see FIG. 3), the pressure drop between inlet and outlet (Equation 4—Table 2; see FIG. 3) falls in the range of ΔP=10⁻⁶-10⁻³ psi, which is well below the membrane leakage threshold of approximately 20 psi reported for submicron pore membranes.

The intermediate compartment is designed to accommodate a fibroblast/collagen scaffold between the two membranes. The flow through collagen, a porous medium, is best described by Darcy's law (Equation 5—Table 2; see FIG. 3) which relates the interstitial flow velocity, vᵢ, to the pressure drop ΔP via the permeability parameter K and liquid viscosity. Flow through extracellular matrix occurs extensively in living tissue (mainly as interstitial flow between blood capillaries and lymphatic drainage) and it has vital functions such as maintaining fluid balance, providing convective transport of proteins and macromolecules, cell-cell signaling and morphogenesis. A number of microfluidic platfoinis have been developed to investigate interstitial flow in vitro and have enabled the measurement of the permeability of rat tail collagen polymerized at a 3 mg/ml concentration (K˜10⁻⁹ -10⁻¹¹ cm²). Chung, S., R. Sudo, V. Vickeinian, L K. Zervantonakis, and R. D. Kamm, Ann of Biomed. Eng. (2010) 38: 1164-1177.

In a chamber with a width of 3000 μm and height of 100 μm and a 10 mm long scaffold, physiological flow velocities of 0.1-1 μm/s (Bonvin, C., J. Overney, A. C. Shieh, J. B. Dixon, and M. A. Swartz, Biotechnol.and Bioeng. (2009) 105: 982-990) can be reached by applying a pressure □P<10⁻³ psi with a flow Q˜0.03 ul/min, resulting in a refreshing of the culture medium every 1.5 hours. Such a long resident time of the medium is expected to allow diffusion and exchange of nutrient with the apical layer. Molecules exchange between the different fluidic compai talents will occur by diffusion across the nanoporous membranes, a phenomenon which depends on the residence time of the solution in the chamber and the molecule diffusivity (Eq. 6). The diffusivity of many molecules is known in water and would suggest a fairly rapid transport across a 10 um thick membrane, but the diffusivity through a nanoporous membrane depends on many specific experimental conditions including its coatings and on the collagen scaffold properties.

### Material Selection

The chambers can be fabricated from a variety of polymers that are suitable for cell cultures including polycarbonate, polyethylene, and acrylic. In one embodiment, polydimethylsiloxane

(PDMS) is utilized for chamber fabrication because the material is well-characterized for cell culture, optically transparent, easy to mold, and cost-efficient for fabrication of single-use systems.

Each polymer chamber layer can be formed in reusable molds. Molds for the chambers can be fabricated by deep reactive ion etching of a lithographically patterned silicon wafer. In one embodiment, the mold can be machined in metal. The resulting system can be assembled by permanent bonding of the polymer with oxygen plasma. Posts in the housing can ensure proper alignment of the three layers during assembly.

Commercial track-etched nanoporous polymer membranes with proven effectiveness in air—liquid interface (ALI) culture can be incorporated using established techniques. Irreversible bonding of polymer membranes to polydimethylsiloxane in a sandwich configuration have been reported using a variety of techniques including plasma-aided bonding, thin glue layer, and a robust direct bond using a aminopropyltriethoxy silane as a chemical crosslinking Ismagilov, R. F., J. M. K. Ng, P. J. A. Kenis, and G. M. Whitesides, Anal. Chem. (2001) 73: 5207-5213; Zhu, X., Microsyst. Technol. (2009) 15: 1459-1465; Aran, K., L. A. Sasso, N. Kamdar, and J. D. Zahn, Lab Chip (2010) 10: 548-552.

The inter-compartment membranes of the system of the present invention provide support for cell attachment and growth and allow diffusion between chambers. The membranes can be glued, crimped or otherwise affixed to the extracellular matrix and fluidic system so that nucleopore size can be optimized for each cell type. In one embodiment, the nucleopore size is typically from about 300 nm to about 500 nm. In a preferred embodiment, the nucleopore size is typically about 400 nm. In a preferred embodiment, the membranes between the cell layers are sheet-like and generally maintained in a horizontal position to emulate the sheet-like structure of epithelium. The porous membranes can be provided in a variety of materials including, but not limited to, polyester, polyvinylidene difluoride (PVDF), polycarbonate, polytetralluoro ethylene (PTFE), or natural materials such as de-cellularized biological matrix.

In a preferred embodiment, a 10 μm thick PET membrane having a 400 nm pore size can be utilized as the epithelium membrane. Such membranes (e.g., COSTAR® TRANSWELL® membranes) are available from Corning Inc. (e.g., Product #3450). A 10 μm PET membrane having a 400 nm pore size can also be utilized as the membrane on the endothelial side. The PET membranes can be irreversibly bonded to polydimethylsiloxane in a sandwich configuration using a variety of techniques including, but not limited to, plasma-aided bonding, thin glue layer, and direct bonding using an aminopropyltriethoxy silane as a chemical crosslinking agent. Aran, K., L. A. Sasso, N. Kamdar, and J .D. Zahn, Lab Chip (2010) 10: 548-552. After bonding, membranes can be coated with collagen type IV (e.g., Sigma C7521) to achieve cell attachment.

### Cell Seeding and Monitoring

Fibroblasts at an optimal density can be seeded in the extracellular matrix chamber in their native serum-containing media with or without additional proteinase inhibitors. After three days of culture, human bronchial epithelial cells can be seeded on the collagen Type (IV)-coated upper surface of the membrane adjacent to the epithelial chamber in air—liquid interface media and allowed to attach overnight. At this point, air—liquid interface media will replace fibroblast media in the middle chamber, with no expected untoward effects on fibroblast survival. In one embodiment, proteinase inhibitors can be added to the air—liquid interface media to minimize epithelial-induced collagen gel degradation. When the epithelium becomes confluent, the system can be inverted and human lung microvascular endothelial cells in their native media can be seeded on the membrane surface in the vascular chamber. After overnight endothelial cell attachment, the system can be placed right side up, and endothelial cell culture media (e.g., EGM-2-MV cell media) can be flowed into the vascular chamber, while maintaining air—liquid interface media in the interstitial chamber.

The device can be planar and fabricated in optically transparent material to enable optical microscopy observation. To aid in microscopic observation with high magnification objectives that have a short working distance, the device thickness can be reduced in the cell culture area. Access to the medium entering and exiting the culture compartment enables a variety of cellular assays. Analysis of effluent enables detection of a variety of cells secretion by a variety of analytical techniques such as ELISA assays. Viability and stress response of the culture can be monitored by MTT reduction, release of lactate dehydrogenase (LDH, via activity assay) and cytokine secretion (typically GROalpha, IL-8, and IL-6 via ELISA) into washings of the epithelial cell apical compartment and in the interstitial and endothelial perfusate. Addition of fluorescent labels or fixative agents to the inlet medium enables staining and cell fixation.

Resistance and potential difference measurements across air-liquid (ALI) or submerged polarized epithelial cell cultures can be routinely measured using a voltohmmeter (EVOM; World Precision Instruments). In one embodiment, modified EVOM electrodes can be inserted into the system's inlets and outlets to capture transepithelial electric resistance (TEER) measurements across the three tissue interfaces between each chamber as well as measure TEER across each interface individually.

Cell fixation and histological sections and transmission electron microscopy (TEM) can be used to evaluate the cell morphology. Immunofluorescent antibody (IFA) staining can be used to identify protein expression, receptors and markers of apoptosis. DNA and RNA extraction protocols can also be performed. The extraction protocols can be performed in conjunction with cell recovery methods such as trypsinization. Analysis of the DNA extracted from cells in the in vitro model can be carried out by PCR and other methods, and RNA analysis can be performed using RT-PCR or other methods. Cells can be enumerated by using either collagenase/trypsinization (for gels and surface grown cells, respectively), followed by manual counting with a hemocytometer or by DNA quantitation using the CyQuant assay (available from Invitrogen™)

In one embodiment, a whole-mount immunostaining approach and analysis by confocal microscopy can be utilized to determine the degree and location of protein expression. Imaging of epithelial organization includes epithelial junctional structures (anti-zonula occludens antibody) and actin fibers (phalloidin). Alternatively, fixation, paraffin embedding, sectioning, can be performed followed by conventional immune-staining.

Barrier integrity and active transport can be characterized by tracking the permeability rates of compounds through the model system by adding compounds (e.g., a fluorescently labeled or radiolabeled compound) to one compartment and evaluating compound concentration from effluent of all three compartments. Forbes, B., A. Shah, G.P. Martin, and A. B. Lansley, Int. J. of Pharm. (2003) 257: 161-167; Mathias, N. R., J. Timoszyk, P. I. Stetsko, J. R. Megill, R. I. Smith, and D. A. I. Wal, J. of Drug Targeting (2002) 10: 31-40; Lin, H., H. Li, H.-J. Cho, S. Bian, H.-J. Roh, M.-K. Lee, J. S. Kim, S.-J. Chung, C.-K. Shim, and D.-D. Kim, J. Pharm. Sci. (2007) 96: 341-349.

### Methods of Use

The system of the present invention can be used to assess and analyze pulmonary drug delivery, conduct toxicology studies, or conduct lung disease or infection studies (e.g., infectious diseases and viral infections). The system of the present invention provides the capability to measure lung barrier and drug transport properties and reproduce lung injury responses.

The system of the present invention also provides the capability to independently challenge and sample the air, interstitial, and vascular chambers to model inhalation exposure and physiological responses involving blood-borne solute/element recruitment. Thus, in one embodiment, the system of the present invention can be used to analyze tissue response to an agent. An agent can be administered to one or more of the layers of the tissue model system and a physiological response or injury to one or more of the epithelial layer, extracellular matrix layer, or endothelial layer can be evaluated. The agent can be at least one drug or pathogen.

The cellular model of this invention allows in vitro investigation of the disposition of drugs delivered via the pulmonary route, including aspects of both their local and systemic effects. For example, the determination of undesirable systemic delivery of compounds designed to be effective locally in the lungs can be investigated. Examples of drug classes used for local administration to the respiratory system include, but are not limited to, β2-agonists, corticosteroids, antibiotics and mucolytics; drugs under development for local pulmonary administration which can include, but is not limited to, chemotherapy for lung tumors, pulmonary gene therapy for delivery of DNA or RNA interference or gene constructs, and vaccines against infectious diseases. Alternatively, the pulmonary route for systemic drug delivery is an attractive option for fast acting drugs to relieve acute symptoms such pain, migraine and nausea. Examples of such fast acting drugs include, but are not limited to, the opioids (e.g., morphine and fentanyl) for treatment of pain or ergotamine for the treatment of migraine. Research has been done on pulmonary administration of growth hormone, parathyroid hormone, and erythropoietin as well as other proteins. Fernandes Vanb ever. Preclinical models for pulmonary drug delivery. Expert Opin. Drug Deliv. (2009) 6(11).

The in vitro model described in this invention can also be used to investigate the local and systemic spread of infectious disease agents including, but not limited to, bacteria (e.g., Mycobacterium tuberculosis, Streptococcus pneumoniae, Staphylococcus aureus) and viruses (e.g., cytomegalovirus, rhinovirus, coronavirus, parainfluenza virus, adenovirus, enterovirus, and respiratory syncytial virus).

A critical component of the host response to toxin or pathogen challenge is the influx of white blood cells, particularly neutrophils, which have also been shown to be capable of epithelial transmigration in vitro. Zemans, R. L., S. P. Colgan, and G. P. Downey, Am J Respir Cell Mol Biol. (2009) 40: 519-535. In one embodiment, the system's culture reproduces the human physiology by adding neutrophils to the vascular chamber and studying their recruitment from the medium and migration across the interstitium and the epithelium. Neutrophils can be isolated from normal human donor blood samples according to established protocols. The cells can be enumerated, fluorescently labeled with cell-tracker red dye, and resuspended in EGM-2-MV cell media. The cells can be flowed across the endothelial side of the system in the presence or absence of epithelial challenge, including sterile culture filtrates of P. aeruginosa strain ATCC 27853, a well-known and potent pro-inflammatory stimulus. Wu, Q., Z. Lu, M. W. Verghese, and S. H. Randell, Respiratory Research (2005) 6: 26. Transmigration can be visualized and quantified in real time by fluorescence microscopy. In such an embodiment, the system of the present invention is typically engineered with an interstitial layer thinner than about 100 μm. Transmigrated cells can be enumerated after washing the epithelial culture surface by manual counting in a hemocytometer.

The system of the present invention can also be used to analyze epithelial repair and reproduce the effect of therapeutic factors application. Therapeutic factors known to enhance epithelial repair in vitro in animal models of lung disease characterized by epithelial injury include, but are not limited to, fibroblast growth factor 10 (FGF10), hepatocyte growth factor (HGF), and keratinocyte growth factor (KGF). Crosby, L. M. and C. M. Waters, Am J Physiol Lung Cell Mol Physiol (2010) 298: L715-L731; Fang, X., A. P. Neyrinck, M. A. Matthay, and J.W. Lee, J Biol Chem. (2010) 285: 26211-26222.

Injury to the epithelial surface can be produced either physically, via mechanically scratching the surface, or chemically with transient exposure of the epithelial surface to dilute polidocanol solutions. The time-course of epithelial regeneration/wound closure following wounding (i.e., physical closure of the induced epithelial breach by migrating cells) can be serially assessed in real time and quantitated optically.

Angiopoietin 1 (ANG1) mediates the positive effect of mesenchymal stem cells on the resolution of lung injury. Each of these factors can be evaluated in air—liquid interface cultures to select a single agent and dose for comparative analysis in the system. To mimic aerosol and IV delivery of therapeutic proteins, a defined, air—liquid interface—optimized dose can be applied to the epithelial and vascular chambers, respectively. Wound closure rates can be monitored and quantified in the presence and absence of the selected growth factor in either the epithelial or vascular chamber.

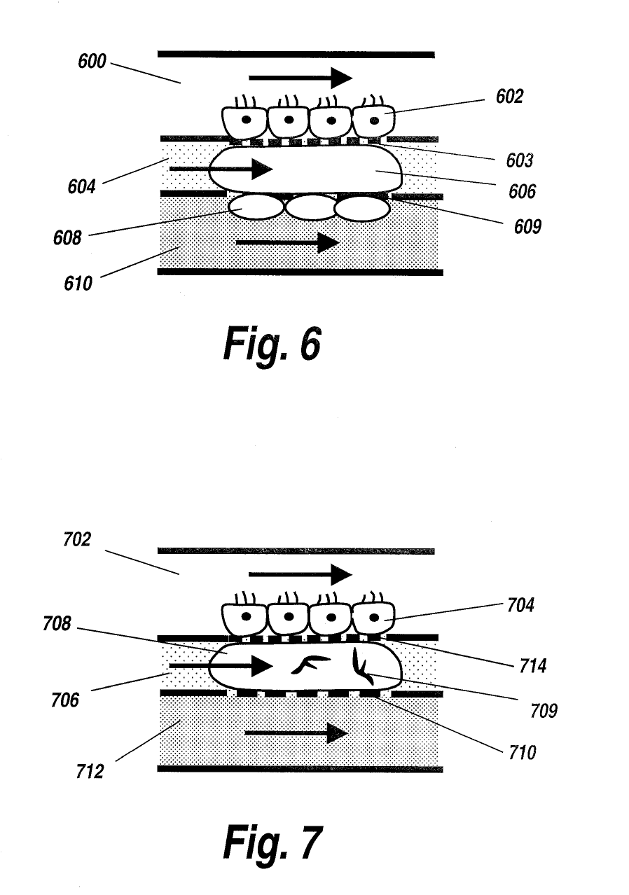

FIG. 6 illustrates one embodiment of the present system that can be used for extravasation experiments of white blood cells. A first chamber 600 includes epithelial cells 602 overlying a nanoporous membrane 603. Cell culture media can flow over the epithelial cells 602 (indicated by arrow) to aid in growth and differentiation, and, at a second time, air can flow through the first chamber 600 to simulate the air-liquid interface of the lung. The extracellular chamber 604 includes acellular collagen 606. Air-liquid interface medium flows through the acellular collagen 606 (indicated by arrow). Endothelial cells 608 are located in a third chamber 610 separated from the extracellular chamber 604 by a nanoporous membrane 609. Media flows across the endothelial cells 608 (indicated by arrow) to aid in growth and differentiation and/or to simulate vascular flow. Transmigration of white blood cells through the system can be assessed and analyzed according to the illustrated embodiment.

FIG. 7 illustrates one embodiment of the present invention that can be used to study pulmonary absorption. According to the illustrated embodiment of FIG. 7, a first chamber 702 includes epithelial cells 704. Cell culture media flows over the epithelial cells 704 (indicated by arrow) to aid in growth and differentiation, and air can flow through the chamber 702 to simulate the air-liquid interface of the lung. The extracellular chamber 706 includes an extracellular matrix 708 seeded with fibroblasts 709. Cell culture media flows through the extracellular matrix 708 (indicated by arrow) to aid in growth and differentiation of the fibroblast cells. Media representing blood flows through a third chamber 712 (indicated by arrow). Nanoporous membranes, 710 and 714, separate the respective chambers. This embodiment of the invention enables assessment and analysis of agents that may enter the system via pulmonary absorption across the air-liquid interface.

Although specific embodiments of the present invention are herein illustrated and described in detail, the invention is not limited thereto. The above detailed descriptions are provided as exemplary of the present invention and should not be construed as constituting any limitation of the invention. Modifications will be obvious to those skilled in the art, and all modifications that do not depart from the spirit of the invention are intended to be included with the scope of the appended claims.

1. An airway tissue model system comprising:
a first chamber having an inlet and an outlet and containing epithelial cells;
a second chamber having an inlet and an outlet and containing an extracellular matrix, wherein the second chamber is separated from the first chamber by a porous membrane; and
a third chamber having an inlet and an outlet, wherein the third chamber is separated from the second chamber by a porous membrane, and wherein the airway tissue model system is configured to provide a separate fluidic pathway through each of said first, second, and third chambers.

2. The airway tissue model system of claim 1, wherein each porous membrane is adapted to provide support for cell attachment and growth and to allow diffusion therethroug h.

3. The airway tissue model system of claim 1, wherein each porous membrane is a nanoporous polyester terephthalate membrane.

4. The airway tissue model system of claim 1, wherein each porous membrane has a pore size from about 300 nm to about 500 nm.

5. The airway tissue model system of claim 1, wherein the first, second, and third chambers are arranged vertically with the first chamber above the second and third chambers in a vertical plane.

6. The airway tissue model system of claim 1, wherein the airway tissue model system is a multi-layer microfluidic device and wherein each of the first, second, and third chambers is formed in a separate layer of the device.

7. The airway tissue model system of claim 1, wherein the fluidic pathways are configured to deliver independent air or liquid media to each of the first, second, and third chambers.

8. The airway tissue model system of claim 1, wherein the epithelial cells are grown at an air-liquid interface in the first chamber.

9. The airway tissue model system of claim 1, wherein the thickness of the second chamber is configured to approximate the capillary-to-epithelium distance in the human conducting airways.

10. The airway tissue model system of claim 1, comprising:
the first chamber vertically arranged above the second chamber, wherein the fluidic pathway through the first chamber is microfluidic and adapted to supply either air or a media adapted to support cell growth and differentiation to the first chamber;
a first porous membrane separating the first chamber from the second chamber and having the epithelial cells seeded on a surface thereof facing the first chamber, the first porous membrane adapted to provide support for cell attachment and growth and to allow diffusion therethrough;
the second chamber having a thickness configured to approximate the capillary-to-epithelium distance in the human conducting airways and wherein the fluidic pathway through the second chamber is microfluidic and adapted to supply a media adapted to support cell growth and differentiation to the second chamber;
a second porous membrane separating the second chamber from the third chamber, the second porous membrane adapted to provide support for cell attachment and growth and to allow diffusion therethrough; and
the third chamber vertically arranged below the second chamber, wherein the fluidic pathway through the third chamber is microfluidic and adapted to supply either a media adapted to support cell growth and differentiation or a fluid adapted to pharmacokinetically mimic blood flow in a human to the third chamber.

11. The airway tissue model system of claim 1, wherein each chamber and each porous membrane is constructed of an optically transparent material.

12. The airway tissue model system of claim 1, wherein the third chamber contains endothelial cells.

13. The airway tissue model system of claim 12, wherein the endothelial cells are human lung microvascular endothelial cells.

14. The airway tissue model system of claim 1, wherein the epithelial cells are human bronchial epithelial cells and the extracellular matrix comprises collagen.

15. The airway tissue model system of claim 1, wherein the extracellular matrix comprises fibroblasts imbedded therein.

16. The airway tissue model system of claim 1, wherein the thicknesses of the chambers is characterized by at least one of the following:
i) the first chamber has a thickness of about 400 μm to about 700 μm;
ii) the second chamber has a thickness of about 50 μm to about 200 μm; and
iii) the third chamber has a thickness of about 100 μm to about 300 μm.

17. A method of analyzing tissue response to an agent comprising:
administering an agent to one or more chambers of the airway tissue model system of claim 1; and
evaluating any physiological response by, or injury to, tissue present in one or more of the chambers.

18. The method of claim 17, wherein the tissue evaluated is one or more of the epithelial cells in the first chamber, the extracellular matrix in the second chamber, and endothelial cells in the third chamber.

19. The method of claim 17, wherein the agent is at least one drug or pathogen.

20. The method of claim 19, wherein the drug or pathogen is administered to one or more chambers simultaneously or in sequence.

21. The method of claim 19, wherein the agent is a drug adapted for pulmonary administration.

22. The method of claim 21, wherein the drug is selected from the group consisting of β2-agonists, corticosteroids, antibiotics, mucolytics, chemotherapy agents, gene therapy agents, vaccines, analgesics, antiemetics, and hormones.

23. The method of claim 17, wherein the method further comprises introducing neutrophils into the fluidic pathway through the third chamber and said evaluating step comprises evaluating transmigration of neutrophils into the first and second chambers.

24. The method of claim 17, wherein the method is adapted to analyze epithelial repair and comprises inducing an injury to at least a portion of the epithelial cells and said evaluating step comprises evaluating epithelial regeneration.
